(19) United States
(12) Patent Application Publication
(10) Pub. No.: US 2019/0176443 A1
(43) Pub. Date: Jun. 13, 2019

(54) FLEXIBLE PACKAGING COMPOSITE FOR THERMALLY PROCESSED, SHELF STABLE, HIGH ACID FOODS

(71) Applicant: CRYOVAC, INC., Charlotte, NC (US)

(72) Inventors: Parimal Vadhar, Greer, SC (US); Matthew Dawe, Simpsonville, SC (US); Matthew Ellis, Greer, SC (US); Suhendra Kartika, Taylors, SC (US)

(21) Appl. No.: 16/320,619

(22) PCT Filed: Jul. 25, 2017
(86) PCT No.: PCT/US17/43702

§ 371 Date: Jan. 25, 2019

Related U.S. Application Data
(60) Provisional application No. 62/521,721, filed on Jun. 19, 2017.
(60) Provisional application No. 62/366,702, filed on Jul. 26, 2016.

(51) Int. Cl. B32B 27/08; B32B 7/12; B32B 27/20; B32B 27/30; B32B 27/32; B32B 27/34; B32B 27/36; B65D 65/40

(52) U.S. Cl. CPC B32B 27/08; B32B 2439/70; B32B 27/20; B32B 27/306; B32B 27/32; B32B 27/34; B32B 27/36; B65D 65/40; B32B 2250/05; B32B 2250/24; B32B 2255/10; B32B 2255/20; B32B 2264/102; B32B 2264/108; B32B 2270/00; B32B 2307/31; B32B 2307/4026; B32B 2307/41; B32B 2307/71; B32B 2439/46; B32B 7/12

(57) ABSTRACT

A multilayer film is provided having barrier protection for high acid foods. The film generally comprises an inorganic core layer comprising a substrate layer upon which an inorganic barrier layer is disposed and at least one outer barrier layer. The outer barrier layer has a core layer that may consist of a barrier layer surrounded by two outer sealant layers. The composite maintains excellent barrier properties at higher temperatures and humidities in order to maintain shelf stable package after it is aseptically or hot filled. The barrier properties of the composite is not significantly affected upon flexing of the film.

### CROSS-REFERENCE TO RELATED APPLICATIONS

This application claims priority to co-pending U.S. Provisional Application No. 62/366,702, filed on Jul. 26, 2016, and U.S. Provisional Application No. 62/521,721, filed on Jun. 19, 2017, which are incorporated herein by reference in their entirety.

### FIELD OF INVENTION

The present invention relates to a multilayer barrier film, laminate thereof, and the process of making the same. The multilayer barrier film of the invention is suitable for food packaging, in particular, thermally processed high acid foods.

### BACKGROUND

Packaging films for food products can merely comprise a mono-layer film or multiple layers joined together using, for example, lamination methods. Conventionally, packaging films for food products are often formed from multilayer polymeric laminates that may be joined by adhesive, extrusion or co-extrusion of the various polymeric layers. Extrusion and co-extrusion techniques have some degree of preference due to their cost-efficiency and high speed manufacturing techniques. Employing adhesives may, at times, lead to a greater expense and variation in film thickness if the adhesive is not evenly applied across the surface.

Multilayer films used in the packaging of food tend to include layers having certain physical and/or chemical properties. For example, a “barrier” layer serves to protect the packaged product from physical stresses as a result of what is expected to be the normal handling of the product during packaging, shipping, and commercial distribution, for example.

A polyamide layer has been found to provide a barrier property to a film. Polyamides may be provided that have favorable physical properties that include high strength, stiffness abrasion and chemical resistance.

A layer or layers may be included that also provide an oxygen scavenger capability. Oxygen may cause packaged foods to spoil. For example, any oxygen exposure may cause conditions that will enhance the growth of microorganisms on the food item. Oxygen scavengers are an active barrier medium that provides additional oxygen scavenging capability when the film is exposed to high moisture condition, for example during hot filling. During that brief exposure period to moisture, both EVOH and nylon based barrier material are known to temporarily reduce their oxygen barrier.

It is also well-known in the art to provide multilayer polymeric films that have high strength, stiffness, abrasion resistance, and/or chemical resistance. For example, a multilayer barrier layer may be constructed that includes at least one layer comprising an ethylene-vinyl alcohol copolymer (EVOH). It is known that the EVOH layer may include a polyamide based layer, typically a polyamide based layer on both sides of the EVOH layer to reduce the cost of as well as the thickness of the multilayer barrier film while still providing superior barrier properties. Nylon layers on each side of EVOH may prevent moisture from reaching the EVOH layer since the EVOH barrier is reduced with high humidity.

There remains a need in the art for a film that provides adequate barrier protection for high acid foods. During the hot filling process, EVOH & nylon 6 barrier drastically reduced with high temperature (approximately 90 to 95° C.) and high relative humidity or RH (approximately 80 to 100%) while an inorganic barrier does not change with RH and humidity

### SUMMARY OF INVENTION

The present invention relates to multilayer films configured to have barrier protection for high acid foods and methods for manufacturing and methods for use of such multilayer films.

In one aspect, the invention provides a multilayer film having an inorganic core layer with a support layer and an inorganic barrier layer and an outer barrier sealant layer upon which the inorganic core layer is disposed. The inorganic barrier of the inorganic core layer may comprise a silicon oxide (SiOₓ) or an aluminum oxide (AlOₓ) or even a combination thereof.

The outer barrier sealant layer may comprise a central core layer, the central core layer comprising a barrier layer having a resin providing barrier properties; a first outer barrier layer upon which the barrier layer is disposed; and a second outer barrier layer disposed on an opposite side of the barrier layer.

The resin of the barrier layer comprises an ethylene vinyl alcohol copolymer (EVOH) according to an embodiment of the invention. In another embodiment of the invention, the resin additionally comprises an oxygen absorber.

In other embodiments of the invention, the barrier layer of the central core layer comprises at least one layer comprising nylon 6. In some embodiments, at least one of the first outer barrier layer and the second outer barrier layer has nylon 6. Further pursuant to this embodiment, at least one of the first outer barrier layer and the second outer barrier layer comprises a maleic anhydride linear low density polyethylene (LLDPE).

The multilayer film, according to certain embodiments of the invention, additionally comprises a first outer layer affixed to a side of the central core layer by a first tie layer. In yet another embodiment of the invention, the multilayer film, additionally comprises a second outer layer affixed to another side of the central core layer by a second tie layer. In certain embodiments of the invention, at least one of the first outer layer and the second outer layer comprises a polyethylene resin that provides a good heat seal in a finished product comprising the multilayer film.

In certain other embodiments of the invention, at least one of the first tie layer and the second tie layer comprises a pigment.

In certain embodiments of the invention, the outer barrier sealant layer comprises a Biaxially Oriented Nylon (BOPA) film.

The multilayer film of the invention may additionally comprise another outer barrier sealant layer on a side of the inorganic core layer opposite to where the outer barrier sealant layer is disposed. In still other embodiments of the invention, the multilayer film may have another inorganic core layer disposed between the inorganic core layer and the another outer barrier sealant layer thus providing two inorganic core layers. As can be appreciated by a person of ordinary skill in the art having the benefit of this disclosure, a multilayer film of the invention may comprise a plurality of inorganic core layers.

An aspect of the invention provide a multilayer film comprising an inorganic core layer having a support layer and an inorganic barrier layer; and, the multilayer film additionally comprises an outer barrier sealant layer upon which the inorganic core layer is disposed.

The inorganic barrier layer may comprise any one of a silicon oxide (SiOₓ) and an aluminum oxide (AlOₓ).

In an embodiment of the invention, the outer barrier sealant layer comprises a central core layer. In certain embodiments of the invention, the central core layer comprises a barrier layer having a resin providing barrier properties; a first outer barrier layer upon which the barrier layer is disposed; and a second outer barrier layer on a side opposite the barrier layer where the first outer barrier layer is disposed.

In certain embodiments of the invention, the resin of the barrier layer comprises an ethylene vinyl alcohol copolymer (EVOH). Further pursuant to this embodiment of the invention, the resin may additionally comprises an oxygen absorber. Still further pursuant to this embodiment of the invention, at least one of the first outer barrier layer and the second outer barrier layer comprises a nylon 6.

In certain other embodiments of the invention, the barrier layer comprises at least one nylon 6 layer. Further pursuant to this embodiment of the invention, at least one of the first outer barrier layer and the second outer barrier layer comprises a maleic anhydride modified linear low density polyethylene (LLDPE).

In an embodiment of the invention, the multilayer film additionally comprises an outer layer affixed to a side of the central core layer by a first tie layer. Further pursuant to this embodiment of the invention, a second tie layer is disposed between another side of the central core layer and the inorganic core layer.

In an embodiment of the invention, the outer layer comprises a polyethylene resin that provides a good heat seal in a finished product comprising the multilayer film. The outer layer may additionally include a pigment. Further pursuant to this embodiment of the invention, the pigment may comprise at least one of a titanium dioxide (TiO₂) and a carbon black. In certain embodiments of the invention, a concentration of the pigment in the outer layer is from about 6 wt % to about 10 wt % based upon the overall weight of the outer layer.

In certain embodiments of the invention, at least one of the first tie layer and the second tie layer comprises a pigment.

In another embodiment of the invention, the multilayer film may comprise another outer barrier sealant layer on a side of the inorganic core layer opposite to where the outer barrier sealant layer is disposed. Further pursuant to this embodiment of the invention, the multilayer film may comprise another inorganic core layer disposed between the inorganic core layer and the another outer barrier sealant layer.

Yet, in certain other embodiments of the invention, the multilayer film may comprise another second tie layer disposed on a side opposite of the inorganic core layer in which the tie layer is disposed and another central core layer disposed between the another second tie layer and another first tie layer. Further pursuant to this embodiment of the invention, at least one of the another first tie layer, the another central core layer, and the another second tie layer have the same properties as the first tie layer, the central core layer, and the second tie layer, respectively.

In another aspect of the invention, a nine layer barrier sealant film is provided having a pigment in the second bulk layer consisting of a polyethylene (PE) resin. In certain embodiments of the invention, a nine layer barrier sealant layer comprises a PE sealant layer, a PE bulk layer, a tie layer, a nylon 6 layer, an EVOH layer, a nylon 6 layer, a tie layer, a PE bulk layer, and a PE layer.

Other aspects and embodiments will become apparent upon review of the following description taken in conjunction with the accompanying drawings. The invention, though, is pointed out with particularity by the included claims.

### BRIEF DESCRIPTION OF THE DRAWINGS

Having thus described the invention in general terms, reference will now be made to the accompanying drawings, which are not necessarily drawn to scale, and wherein:

FIG. 1 is a cross-sectional side view of a multilayer film in accordance with the present invention;

FIG. 2 is a cross-sectional view of a barrier sealant layer in accordance with an embodiment of the invention;

FIG. 3 is a cross-sectional side view of a multilayer film in accordance with another embodiment of the present invention;

FIG. 4 is a cross-sectional side view of a multilayer film in accordance with yet another embodiment of the present invention;

FIG. 5 is a cross-sectional side view of a multilayer film in accordance with yet another embodiment of the present invention;

FIG. 6 is a graphical representation of the change in L value for Film1 during accelerated test conditions for aseptic and hot fill processing;

FIG. 7 is a graphical representation of the change in L value for Film1, Film2 and Film 3 during accelerated test conditions for hot fill processing; and

FIG. 8A is a graphical representation of the change in the CIE L* value for Film4, Film5 and Film1 during accelerated test conditions for aseptic processing;

FIG. 8B is a graphical representation of the change in the CIE b* value for Film4, Film5 and Film1 during accelerated test conditions for aseptic processing;

FIG. 9A is a graphical representation of the change in the CIE L* value for Film4, Film5 and Film1 during accelerated test conditions for hot fill processing;

FIG. 9B is a graphical representation of the change in the CIE b* value for Film4, Film5 and Film1 during accelerated test conditions for hot fill processing;

FIG. 10A is a graphical representation of the change in the CIE L* value for Film4, Film5 and Film1 during ambient test conditions for aseptic processing;

FIG. 10B is a graphical representation of the change in the CIE b* value for Film4, Film5 and Film1 during ambient test conditions for aseptic processing;

FIG. 11A is a graphical representation of the change in the CIE L* value for Film4, Film5 and Film1 during ambient test conditions for hot processing;

FIG. 11B is a graphical representation of the change in the CIE b* value for Film4, Film5 and Film1 during ambient test conditions for hot processing.

### DETAILED DESCRIPTION OF THE INVENTION

The present invention now will be described more fully hereinafter with reference to the accompanying drawings, in which some, but not all embodiments of the inventions are shown. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “a film” includes a plurality of such films.

It will be understood that relative terms, such as “preceding” or “followed by” or the like, may be used herein to describe one element's relationship to another element as, for example, may be illustrated in the Figures. It will be understood that relative terms are intended to encompass different orientations of the elements in addition to the orientation of elements as illustrated in the Figures. It will be understood that such terms can be used to describe the relative positions of the element or elements of the invention and are not intended, unless the context clearly indicates otherwise, to be limiting.

Embodiments of the present invention are described herein with reference to various perspectives, including, for example, perspective views that are representations of idealized embodiments of the present invention. As a person having ordinary skill in the art would appreciate, variations from or modifications to the shapes as illustrated in the Figures or the described perspectives are to be expected in practicing the invention. Such variations and/or modifications can be the result of manufacturing techniques, design considerations, and the like, and such variations are intended to be included herein within the scope of the present invention and as further set forth in the claims that follow. The articles of the present invention and their respective components described or illustrated in the Figures are not intended to reflect a precise description or shape of the component of an article and are not intended to limit the scope of the present invention.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

An object of the invention is to maintain as great of barrier capability as possible. The multilayer barrier films of the invention have a sufficient barrier capability allowing for the use of this films to package food in pouches instead of in metal cans and still have a high barrier capability. While an oxygen transmission rate (OTR) through metal especially treated metal can approach zero, the inventors have found that the films of the invention rival the use of metal as a packaging material. The films of the invention have an OTR that is 0.01 cc/sqm or lower allowing shelf life of a packaged product to be extended, to preserve the color of the packaged product over time, and to maintain the flavor of the packaged product.

Additionally, it has been found that a low pH or higher acidity helps to preserve a packaged food product. In some cases, for example, food companies add ascorbic acid in a mango puree to achieve better shelf life. The films of the invention, however, allow for the “natural” product to be packaged without a need to add preservatives that lower the pH of the product. Some companies may also add sugar that helps to bind free water and extend the shelf life. Again, the films of the invention alleviate the need for sugar to be added as well.

The invention described herein relates to a multilayer film, in particular, a multilayer film capable of acting as an oxygen barrier and a moisture barrier for high acid foods or such foods having a pH of less than 4.5. The multilayer film generally comprises three or more layers. In an embodiment of the invention, the multilayer film comprises a core layer having an inorganic barrier and an outer layer affixed to both sides of the core layer. In an embodiment of the invention, at least one of the outer layers comprises a nylon. In another embodiment of the invention, at least one of the outer layers comprises nylon and an ethylene-vinyl alcohol copolymer (EVOH). The inorganic barrier of the core layer may comprise one or more SiOₓ, one or more AlOₓ, and any combination thereof.

The multilayer film composite may be clear or a white and/or black pigment may be used to provide a white, gray or black optical appearance. In certain embodiments of the invention, a white pigmented optical appearance may be provided by a filler comprising titanium dioxide (TiO₂). In certain embodiments of the invention, a black pigmented optical appearance is provided by a filler comprising carbon black. In certain embodiments of the invention, a gray pigmented optical appearance is provided by a filler comprising TiO₂ and carbon black. Further pursuant to this embodiment of the invention, the amount of TiO₂ and carbon black may be varied to provide the desired extent of grayness to be achieved.

In an embodiment of the invention, the concentration of the filler is from about 1 wt % to about 20 wt %, from about 5 wt % to about 15 wt %, or from about 6 wt % to about 10 wt % based upon the overall weight of the layer in which the pigment is based.

In another embodiment of the invention, the pigment comprises TiO₂ and carbon black. Further pursuant to this embodiment, the concentration of the TiO₂ is from about 1 wt % to about 10 wt %, from about 5 wt % to about 8 wt %, or from about 6 wt % to about 7 wt %, while the concentration of the carbon black is from about 0.1 wt % to about 2 wt %, from about 0.2 wt % to about 1 wt&, or from about 0.3 wt % to about 0.5 wt % all based upon the overall weight of the layer in which the pigments are based.

While a white-based pigment such as TiO₂ acts as a good UV protectant, other additives to provide UV protection may also be included in any of the layers especially in those instants when a clear multilayer film is preferred. In an embodiment of the invention, a fluorescent brightening agent is included in at least one of the layers. In certain embodiments of the invention, a UV protectant absorbs UV light in a range of about 300 nm to about 425 nm.

As used herein, an “oxygen scavenger” is a compound or a combination of compounds that that are included in a layer to help to scavenge oxygen allowing the layer to become more of an active barrier while the included resins is more of a passive layer. In an embodiment of the invention, one or more oxygen scavengers are include with EVOH to allow the layer to become more of an active oxygen barrier layer. Under certain circumstances, a barrier layer that has been made active by an oxygen scavenger may have a limited capacity and become less active or not at all active after a certain time. Many times, this really depends upon the level of oxygen ingress into the active barrier layer.

In certain embodiments of the invention, while an EVOH layer has a very high barrier activity and a combination of Nylon 6 layers have a medium barrier activity. However, it is known that barrier capability becomes reduced with higher humidity, especially when the humidity is greater than 80% relative humidity (RH). In certain embodiments of the invention, an oxygen scavenger is included to assist with maintaining the barrier capability of these layers at high humidity by scavenging oxygen that goes into the packaged product. In an embodiment of the invention, an inorganic barrier is provide to maintain the barrier capability regardless of RH and temperature.

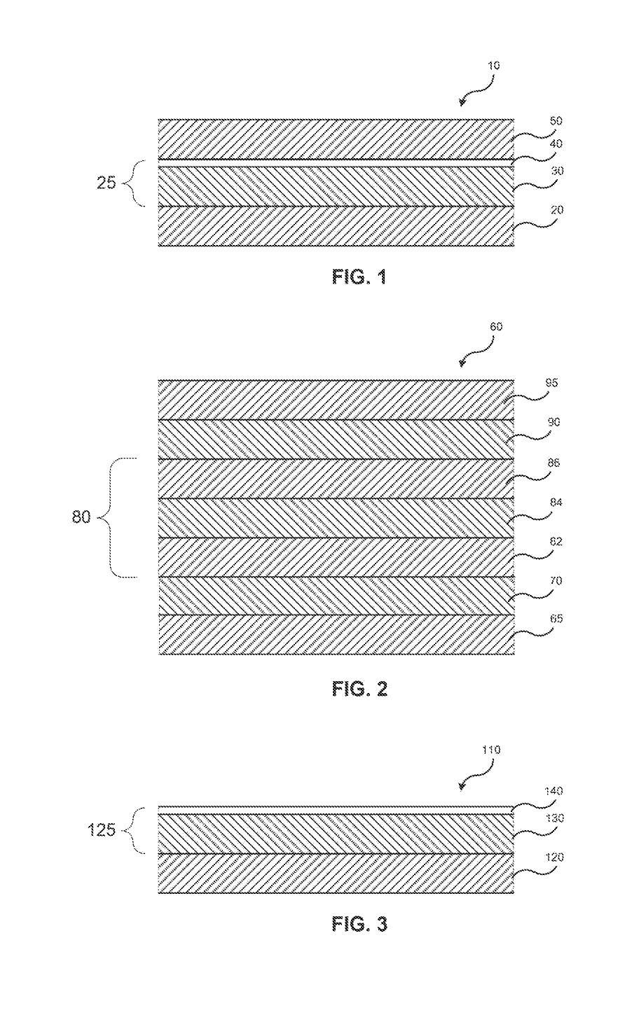

FIG. 1 is a cross-sectional side view of a multilayer film in accordance with an embodiment of the invention. The multilayer film 10 comprises an inorganic core layer 25 having a support layer 30 and an inorganic barrier layer 40. According to an embodiment of the invention, the support layer 30 may be coated with the inorganic barrier layer 40. In this exemplary embodiment of the invention, the inorganic core layer 25 is surrounded by an outer barrier sealant layer 20 and another outer barrier sealant layer 50.

In an embodiment of the invention, the outer barrier sealant layer 20 and the another outer barrier sealant layer 50 have substantially the same configuration. In another embodiment of the invention, the outer barrier sealant layer 20 and the another outer barrier sealant layer 50 have different configurations.

In an embodiment of the invention, the support layer 30 comprises a resin, preferably an organic resin. In certain embodiments of the invention, the support layer 30 comprises a polyester. In an embodiment of the invention, the inorganic barrier layer 40 comprises at least one of a silicon oxide (SiOₓ) and an aluminum oxide (AlOₓ). In certain preferred embodiments of the invention, only one inorganic barrier type—i.e., either silicon or aluminum based—are used in a film structure. Preferably, the inorganic layer is chosen to maintain excellent barrier functionality even after flexing and after being subject to varying temperature and humidity extremes.

Without intending to be bound by theory, a barrier sealant layer may act as, among other things, a gas barrier, in a non-limiting example, preventing oxygen from penetrating the film; an unpleasant odor barrier preventing such odor causing compounds from sneaking into a packaged item; a pleasant flavor and/or aroma barrier keeping such compounds that provide this flavor and/or pleasant aroma in an item, a food item for example, that is packaged using the film; a moisture barrier preventing the transfer of moisture, for example, into the packaged item; and liquid barrier, for example, an organic liquid barrier layer. The barrier sealant layer itself, in many cases, is a multilayer laminate film structure.

FIG. 2 is a cross-sectional view of a barrier sealant layer in accordance with an embodiment of the invention. A barrier sealant layer 60 illustrated in FIG. 2 comprises a central core layer 80. In this exemplary embodiment, the central core layer 80 comprises three layers. In an embodiment of the invention, the central core layer 80 comprises a barrier layer 84 having a resin providing barrier properties, typically a resin with excellent barrier properties. In an embodiment of the invention, the barrier layer 84 comprises an ethylene vinyl alcohol copolymer (EVOH). Further pursuant to this embodiment of the invention, the EVOH is represented by the following:

—(CH₂—CH₂)ₘ—(CH₂—CHOH)ₙ—

In an embodiment of the invention, the barrier layer 84 may additionally comprise an oxygen absorber. In certain embodiments of the invention, a thickness of the barrier layer 84 is minimized to provide a high impact strength for a film using the barrier sealant layer 60.

In the exemplary embodiment represented by FIG. 2, the barrier layer 84 is disposed between a first outer barrier layer 82 and a second outer barrier layer 86. The second outer barrier layer 86 may be on the side opposite of the barrier layer 84 where the first outer barrier layer 82 is disposed. Preferably, one or both of the first outer barrier layer 82 and the second outer barrier layer 86 provide some barrier characteristic as further detailed herein. In an embodiment of the invention, at least one of the first outer barrier layer 82 and the second outer barrier layer 86 comprises a polyamide.

In a certain embodiment of the invention, the central core layer 80 has the first outer barrier layer 82 and the second outer barrier layer 86 with the barrier layer 84 disposed in between, wherein the first outer barrier layer 82, the barrier layer 84 and the second outer barrier layer 86 each comprise a nylon, wherein the thickness of each of the first outer barrier layer 82, the barrier layer 84 and the second outer barrier layer 86 is minimized. In some embodiments, the nylon may be nylon 6. The barrier layer 84 may have at least one nylon 6 layer. The first outer barrier layer 82, the second outer barrier layer 86, or both may have LLDPE. In some embodiments of the invention, the LLDPE may be maleic anhydride modified LLDPE. Without intending to be bound by theory, a barrier sealant layer 60 having such a central core layer 80 with this configuration offers good impact strength to a finished film including such a barrier sealant layer 60.

As shown in FIG. 2, the barrier sealant layer 60 may further comprise a first outer layer 65 and a second outer layer 95, wherein the first outer layer 65 and the second outer layer 95 are configured to provide certain desirable properties to the barrier sealant layer 60. Further pursuant to the exemplary embodiment represented by FIG. 2, a first tie layer 70 interfaces the first outer layer 65 to the central core layer 80 and a second tie layer 90 interfaces the second outer layer 95 to the central core layer 80. The first tie layer 70 and/or the second tie layer 90 may include an adhesive and function, at least in part, as a sealant between the first outer layer 65 and the central core layer 80 and/or the second outer layer 95 and the central ore layer 80. In an embodiment of the invention, the first tie layer 70, the second tie layer 90 or both may have a pigment. In other embodiments, the first outer layer 65, the second outer layer 95, or both may have a pigment. The concentration of the pigment may be about 6 wt % to about 10 wt % based upon an overall weight of the first outer layer 65, the second outer layer 95, or both. In varying embodiments of the invention, the pigment may be a white pigment such as, for example, titanium dioxide, a black pigment such as, for example, carbon black, or a combination thereof to provide, for example a grayscale tone to the barrier sealant layer 60. In certain embodiments of the invention, the pigments or even other additives included in the second tie layer 90 or, optionally, the first tie layer 70 provides a at least one of a UV light barrier, light transmission control, and/or a certain degree of opacity.

According to an embodiment of the invention, the first outer layer 65 may comprise a resin, preferably, an organic resin. In an embodiment of the invention, the first outer layer 65 comprises a polyethylene, preferably, a linear low density polyethylene (LLDPE). According to an embodiment of the invention, the second outer layer 95 may comprise a resin, preferably, an organic resin. In an embodiment of the invention, the first outer layer 65 comprises a polyethylene, preferably, a LLDPE.

In an embodiment, a polyethylene resin of one of the first outer layer 65 and the second outer layer 95 is chosen to provide a good heat seal in a finished film utilizing this barrier sealant layer 60 of the invention. In another embodiment of the invention, one of the first outer layer 65 and the second outer layer 95 comprises a slip and/or antiblock additive allowing the chosen layer to have a low coefficient of friction. Further pursuant to this embodiment of the invention, the resin of the first outer layer 65 and the second outer layer 95 that does not include the slip additive to provide a strong bond to the inorganic barrier layer of the barrier layer. The layer may also, according to certain embodiments of the invention, be corona treated to provide good adhesion during the lamination process.

FIG. 3 is a cross-sectional side view of a multilayer film in accordance with another embodiment of the present invention. The multilayer film 110 comprises an inorganic core layer 125 having a support layer 130 and an inorganic barrier layer 140, wherein the support layer 130 and/or the inorganic barrier layer 140 may have the properties as defined herein. According to an embodiment of the invention, the support layer 130 may be coated with the inorganic barrier layer 140. In this exemplary embodiment of the invention, the multilayer film 110 includes an outer barrier sealant layer 120, wherein the outer barrier sealant layer 120 may have the properties as defined herein.

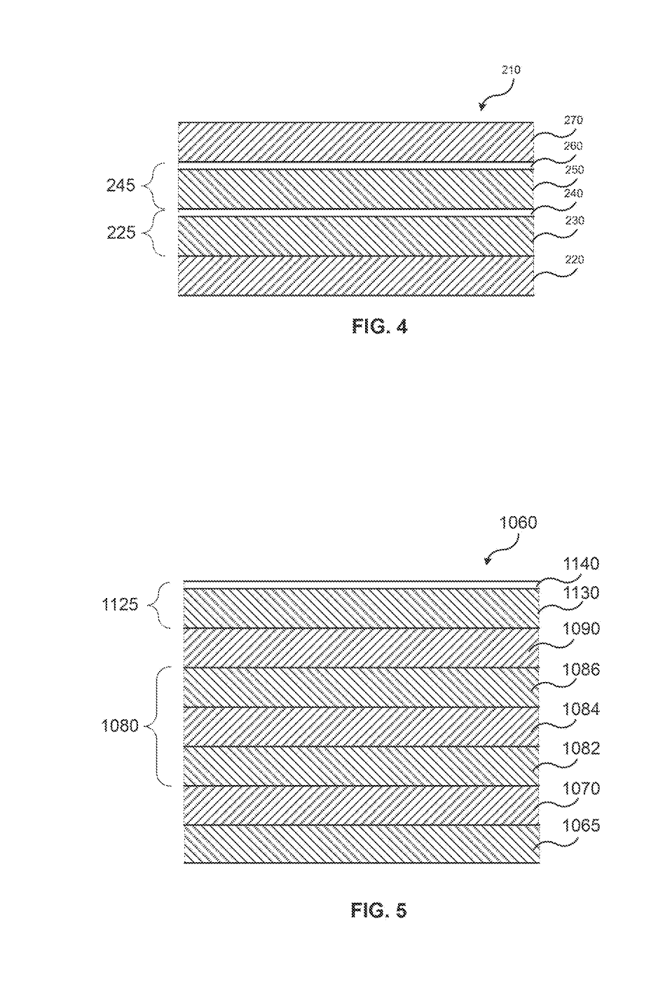

FIG. 4 is a cross-sectional side view of a multilayer film in accordance with yet another embodiment of the present invention. The multilayer film 210 comprises a first inorganic core layer 225 having a first support layer 230 and a first inorganic barrier layer 240, wherein the first support layer 230 and/or the first inorganic barrier layer 240 may have the properties as defined herein. The multilayer film 210 additionally comprises a second inorganic core layer 245 having a second support layer 250 and a second inorganic barrier layer 260, wherein the second support layer 250 and/or the second inorganic barrier layer 260 may have the properties as defined herein. According to an embodiment of the invention, the first inorganic core layer 225 and the second inorganic layer 245 may be substantially the same. The second inorganic core layer 245 may be disposed between the first inorganic core layer 225 and another outer barrier sealant layer 270. According to another embodiment of the invention, the first inorganic core layer 225 and the second inorganic core layer 245 may be structured differently in whole or in part. In this exemplary embodiment of the invention, the first inorganic core layer 225 and the second inorganic core layer 245 are disposed between an outer barrier sealant layer 220 and another outer barrier sealant layer 270, wherein the outer barrier sealant layer 220 and the another outer barrier sealant layer 270 may have the properties as defined herein.

FIG. 5 is a cross-sectional side view of a multilayer film in accordance with yet another embodiment of the present invention. The multilayer film of FIG. 5 combines the central core layer 80 of FIG. 2 with the inorganic core layer 125 of FIG. 3. A barrier sealant layer 1060 illustrated in FIG. 5 comprises a central core layer 1080. The central core layer 1080 comprises three layers, in this exemplary embodiment, comprising a barrier layer 1084 having a resin providing barrier properties, typically a resin with excellent barrier properties. In an embodiment of the invention, the barrier layer 1084 comprises an ethylene vinyl alcohol copolymer (EVOH). In an embodiment of the invention, the barrier layer 1084 may additionally comprise an oxygen absorber. In certain embodiments of the invention, a thickness of the barrier layer 1084 is minimized to provide a high impact strength for a film using the multilayer film of FIG. 5. In the exemplary embodiment represented by FIG. 5, the barrier layer 1084 is disposed between a first outer barrier layer 1082 and a second outer barrier layer 1086. The second outer barrier layer 1086 may be on the side opposite of the barrier layer 1084 where the first outer barrier layer 1082 is disposed. Preferably, one or both of the first outer barrier layer 1082 and the second outer barrier layer 1086 provide some barrier characteristic as further detailed herein and may include any of the resins further taught herein.

As further shown in FIG. 5, the barrier sealant layer 1060 may further comprise a first outer layer 1065 and an inorganic core layer 1125, wherein the first outer layer 1065 and the inorganic core layer 1125 are configured to provide certain desirable properties to the barrier sealant layer 1060. Further pursuant to the exemplary embodiment represented by FIG. 5, a first tie layer 1070 interfaces the first outer layer 1065 to the central core layer 1080 and a second tie layer 1090 interfaces the inorganic core layer 1125 to the central core layer 1080. The first tie layer 1070 and/or the second tie layer 1090 may include an adhesive and function, at least in part, as a sealant between the first outer layer 1065 and the central core layer 80 and/or the inorganic barrier layer 1125 and the central ore layer 1080.

The inorganic core layer 1125 of the embodiment illustrated in FIG. 5 comprises a support layer 1130 and an inorganic barrier layer 1140, wherein the support layer 1130 and/or the inorganic barrier layer 1140 may have the properties as defined herein. According to an embodiment of the invention, the support layer 1130 may be coated with the inorganic barrier layer 1140. Although not illustrated in FIG. 5, any other film layer and/or film layer combination may be disposed on a side opposite of the inorganic core layer 1125 where the second tie layer 1090 is disposed.

Pigments, as disclosed herein, may be included in any one or any combination of the barrier sealant layer 1060, the first outer layer 1065, the first tie layer 1070 and the second tie layer 1090. Of course, the multilayer film of FIG. 5 may comprise the dual inorganic layer structure illustrated in FIG. 4 as well, but this has not been illustrated in the figures.

An aspect provides a vertical form fill seal film formulation comprising a multilayer film of the invention. Such a vertical form fill seal has good, if not excellent, relative oxygen (OTR) and moisture barrier (MVTR) properties particularly for high acid foods, which are typically foods defined as having a pH of about 6 or less. In certain embodiments of the invention, the pH may be about 4.6 or less, and, in some cases, about 4.5 or less.

### EXAMPLES

Various examples of the inventive subject matter include the multilayer films as described herein. Tables 1A through 1E provide a generalized description of the configuration of the various multilayer films that have been tested.

TABLE 1A
Single Layer SiOₓ Coated PET Film

| Film | Thickness | |
|---|---|---|
| Region | microns | Film Region Description |
| 1 | 68 | White/gray barrier sealant |
| 2 | 0.5 | Adhesive |
| 3 | 12 | SiOₓ coated PET |
| 4 | 0.5 | Adhesive |
| 5 | 45 | White barrier sealant |

TABLE 1B
Two Layer SiOₓ Coated PET Films

| Film | Thickness | |
|---|---|---|
| Region | microns | Film Region Description |
| 1 | 45 | White barrier sealant |
| 2 | 0.5 | Adhesive |
| 3 | 12 | SiOₓ coated PET |
| 4 | 0.5 | Adhesive |
| 5 | 12 | SiOₓ coated PET |
| 6 | 0.5 | Adhesive |
| 7 | 45 | White barrier sealant |

TABLE 1C
Single Layer SiOₓ Coated PET Film/Thinner White Barrier Sealant

| Film | Thickness | |
|---|---|---|
| Region | microns | Film Region Description |
| 1 | 45 | White barrier sealant |
| 2 | 0.5 | Adhesive |
| 3 | 12 | SiOₓ coated PET |
| 4 | 0.5 | Adhesive |
| 5 | 45 | White barrier sealant |

TABLE 1D
Single Layer SiOₓ Coated PET Film

| Film | Thickness | |
|---|---|---|
| Region | microns | Film Region Description |
| 1 | 12 | SiOₓ coated PET |
| 2 | 0.5 | Adhesive |
| 3 | 15 | Biaxially Oriented Nylon (BOPA) Film |
| 4 | 0.5 | Adhesive |
| 5 | 25 | Cast polypropylene |

TABLE 1E
Single Layer SiOₓ Coated PET Film
without a White Barrier Sealant

| Film | Thickness | |
|---|---|---|
| Region | microns | Film Region Description |
| 1 | 21 | Polyethylene-based Layer |
| 2 | 5 | Tie |
| 3 | 12 | One or more Nylon Layers |
| 4 | 5 | Tie |
| 5 | 21 | Polyethylene-based Layer |

An exemplary white barrier sealant is identified in Table 2.

TABLE 2
Exemplary White Barrier Sealant

| | Film | | Layer |
|---|---|---|---|
| Layer | % | Compound | Wt % |
| 1 | 13.1 | Low density polyethylene (LDPE) | 99.1 |
| | | Slip additive | 0.9 |
| 2 | 20.0 | Linear low density polyethylene (LLDPE) | 6.9 |
| | | White masterbatch | 2.5 |
| 3 | 11.6 | LDPE | 100.0 |
| 4 | 6.5 | LLDPE | 67.0 |
| | | Tie | 33.0 |
| 5 | 4.2 | Polyamide, alternative polyamide composite | 100.0 |
| 6 | 8.9 | EVOH, alternate EVOH composite | 100.0 |
| 7 | 4.2 | Polyamide, alternative polyamide composite | 100.0 |
| 8 | 6.5 | LLDPE | 67.0 |
| | | Tie | 33.0 |
| 9 | 25.0 | LLDPE | 1.2 |
| | | LDPE | 48.0 |
| | | Modified-LLDPE | 49.8 |
| | | Antioxidant | 0.5 |
| | | Polyphthalamide | 0.5 |

Specific examples of the inventive concept will now be described and are further defined in Table 3. The examples that follow are provided only for illustrative purposes only.

TABLE 3
Exemplary Multilayer Films Subject to Analysis

| | | Film1 | | Film2 | | Film3 | |
|---|---|---|---|---|---|---|---|
| | | Table 1A | | Table 1B | | Table 1C | |
| | | Thick | Comp | Thick | Comp | Thick | Comp |
| Layer | Component | mils | wt % | mils | wt % | mils | wt % |
| 1 | Linear Low Density Polyethylene | 0.91 | 80.0 | 0.27 | 0.0 | 0.27 | 0.0 |
| | (LLDPE) | | | | | | |
| | Low Density Polyethylene (LDPE) | | 0.0 | | 99.1 | | 99.1 |
| | High Density Polyethylene (HDPE) | | 6.4 | | 0.0 | | 0.0 |
| | Ethylene/Hexene Copolymer | | 1.4 | | 0.0 | | 0.0 |
| | Ethylene/Octene Copolymer | | 3.6 | | 0.0 | | 0.0 |
| | Antiblock and Slip Additive | | 1.6 | | 0.9 | | 0.9 |
| | Titanium Dioxide | | 6.5 | | 0.0 | | 0.0 |
| | Carbon Black | | 0.4 | | 0.0 | | 0.0 |
| 2 | LLDPE | 0.27 | 10.0 | 0.32 | 93.5 | 0.32 | 93.5 |
| | Maleic Anhydride-modified LLDPE | | 80.0 | | 0.0 | | 0.0 |
| | Titanium Dioxide | | 10.0 | | 6.5 | | 6.5 |
| 3 | Polyamide-6 | 0.27 | 100.0 | 0.21 | 0.0 | 0.21 | 0.0 |
| | LDPE | | 0.0 | | 100.0 | | 100.0 |
| 4 | LLDPE | 0.32 | 0.0 | 0.12 | 67.0 | 0.12 | 67.0 |
| | Hydrolyzed Ethylene/Vinyl Acetate | | 50.0 | | 0.0 | | 0.0 |
| | (EVA) Copolymer | | | | | | |
| | Hydrolyzed EVA with O₂ Scavenger | | 50.0 | | 0.0 | | 0.0 |
| | Tie | | 0.0 | | 33.0 | | 33.0 |
| 5 | Polyamide-6 | 0.27 | 100.0 | 0.07 | 100.0 | 0.07 | 100.0 |
| 6 | LLDPE | 0.38 | 6.0 | 0.16 | 0.0 | 0.16 | 0.0 |
| | Maleic Anhydride-modified LLDPE | | 88.0 | | 0.0 | | 0.0 |
| | Ethylene Vinyl Alcohol (EVOH) | | | | 100.0 | | 100.0 |
| | Titanium Dioxide | | 6.0 | | 0.0 | | 0.0 |
| 7 | LLDPE | 0.27 | 27.1 | 0.07 | 0.0 | 0.07 | 0.0 |
| | HDPE | | 3.2 | | 0.0 | | 0.0 |
| | Ethylene/Hexene Copolymer | | 1.4 | | 0.0 | | 0.0 |
| | Ethylene/Norbornene Copolymer | | 60.0 | | 0.0 | | 0.0 |
| | Polyamide-6 | | 0.0 | | 100.0 | | 100.0 |
| | Antiblock and Slip Additive | | 0.8 | | 0.0 | | 0.0 |
| | Titanium Dioxide | | 7.5 | | 0.0 | | 0.0 |
| 8 | LLDPE | 0.02 | 0.0 | 0.12 | 67.0 | 0.12 | 67.0 |
| | Tie | | 0.0 | | 33.0 | | 33.0 |
| | Adhesive | | 100.0 | | 0.0 | | 0.0 |
| 9 | Polyethylene Terephthalate (PET)- | 0.48 | 100.0 | 0.44 | 0.0 | 0.44 | 0.0 |
| | Silicon Oxide Coated | | | | | | |
| | LLDPE | | 0.0 | | 1.2 | | 1.2 |
| | Modified-LLDPE (mLLDPE) | | 0.0 | | 49.8 | | 49.8 |
| | LDPE | | 0.0 | | 48.0 | | 48.0 |
| | Antioxidant | | 0.0 | | 0.5 | | 0.5 |
| | Polyphthalamide | | 0.0 | | 0.5 | | 0.5 |
| 10 | Adhesive | 0.02 | 100.0 | 0.02 | 100.0 | 0.02 | 100.0 |
| 11 | PET-Silicon Oxide Coated | 1.77 | 0.0 | 0.48 | 100.0 | 0.48 | 100.0 |
| | Commercially Available Film | | 100.0 | | 0.0 | | 0.0 |
| 12 | Adhesive | | | 0.02 | 100.0 | 0.02 | 100.0 |
| 13 | PET-Silicon Oxide Coated | | | 0.48 | 100.0 | 0.27 | 0.0 |
| | LLDPE | | | | 0.0 | | 99.1 |
| | Antiblock and Slip Additive | | | | 0.0 | | 0.9 |
| 14 | LLDPE | | | 0.02 | 0.0 | 0.32 | 93.5 |
| | Titanium Dioxide | | | | 0.0 | | 6.5 |
| | Adhesive | | | | 100.0 | | 0.0 |
| 15 | LDPE | | | 0.27 | 99.10 | 0.21 | 100.0 |
| | Antiblock and Slip Additive | | | | 0.9 | | 0.0 |
| 16 | LLDPE | | | 0.32 | 93.5 | 0.12 | 67.0 |
| | Titanium Dioxide | | | | 6.5 | | 0.0 |
| | Tie | | | | 0.0 | | 33.0 |
| 17 | LDPE | | | 0.21 | 100.0 | 0.07 | 0.0 |
| | Polyamide-6 | | | | 0.0 | | 100.0 |
| 18 | LLDPE | | | 0.12 | 67.0 | 0.16 | 0.0 |
| | EVOH | | | | 0.0 | | 100.0 |
| | Tie | | | | 33.0 | | 0.0 |
| 19 | Polyamide-6 | | | 0.07 | 100.0 | 0.07 | 100.0 |
| 20 | LLDPE | | | 0.16 | 0.0 | 0.12 | 67.0 |
| | EVOH | | | | 100.0 | | 0.0 |
| | Tie | | | | 0.0 | | 33.3 |
| 21 | LLDPE | | | 0.07 | 0.0 | 0.44 | 1.2 |
| | mLLDPE | | | | 0.0 | | 49.8 |
| | LDPE | | | | 0.0 | | 48.0 |
| | Polyamide-6 | | | | 100.0 | | 0.0 |
| | Antioxidant | | | | 0.0 | | 0.5 |
| | Polyphthalamide | | | | 0.0 | | 0.5 |
| 22 | LLDPE | | | 0.12 | 67.0 | | |
| | Tie | | | | 33.0 | | |
| 23 | LLDPE | | | 0.44 | 1.2 | | |
| | mLLDPE | | | | 49.8 | | |
| | LDPE | | | | 48.0 | | |
| | Antioxidant | | | | 0.5 | | |
| | Polyphthalamide | | | | 0.5 | | |

### Example 1

Film1 was subjected to accelerated aseptic processing testing, ambient aseptic processing testing, accelerated hot fill processing testing, and ambient hot fill processing testing. Accelerated process testing for Film1 was conducted at 45° C. Aseptic processing involved filling a sterile pouch fabricated from the multilayer film being tested with sterile mango pulp at room temperature. Hot fill processing involved heating the mango pulp to 95° C. followed by filling the sterile pouch fabricated from the multilayer film being tested while the mango pulp was heated. After packaging, the hot filled pouch is subjected to cooling. Prior to filling the pouch, the mango pulp is deaerated to reduce the amount of any trapped oxygen. Any headspace remaining in the pouch is substantially eliminated upon filling the pouch with the mango pulp followed by sealing of the pouch. Accelerated processing involves subjecting the filled pouch to increased temperature, while ambient processing involves only subjecting the filled pouch to ambient conditions.

The pouch including the mango pulp is subjected to a colorimetric test from which the Lab color space of L-a-b values are determined. Of these values, the L value, which is indicative of the extent of lightness tends to be a good variable to monitor to determine whether there is a substantive change in the color of the packaged material. The a and b values are indicative of the color-opponent dimensions.

The variation in L values for Film1 from the baseline over the course of testing has been identified in Tables 4A, 4B, 4C and 4D representing accelerated aseptic processing testing, ambient aseptic processing testing, accelerated hot fill processing testing and ambient hot fill processing testing, respectively.

TABLE 4A
Film1 Accelerated Aseptic Processing L Value

| Sample | | 1 | 2 | 3 | 4 | |
|---|---|---|---|---|---|---|
| Number | Baseline | Month | Month | Month | Month | Reduction |
| 1 | 51.08 | 50.58 | 49.76 | 48.05 | 46.23 | −9.5% |
| 2 | 51.24 | 50.63 | 49.98 | 47.83 | 46.18 | −9.9% |
| 3 | 51.03 | 50.50 | 50.07 | 48.34 | 46.20 | −9.5% |
| 4 | 51.21 | 50.84 | 49.34 | 48.19 | 46.17 | −9.8% |
| 5 | 51.04 | 50.85 | 49.41 | 48.42 | 46.61 | −8.7% |
| 6 | 50.97 | 50.95 | 49.32 | 48.59 | 46.33 | −9.1% |
| 7 | 51.22 | 51.14 | 49.65 | 47.89 | 45.69 | −10.8% |
| 8 | 50.79 | 51.11 | 49.63 | 47.85 | 45.81 | −9.8% |
| 9 | 51.04 | 51.13 | 49.69 | 47.92 | 45.99 | −9.9% |
| Avg | 51.07 | 50.86 | 49.65 | 48.12 | 46.13 | −9.7% |
| StdDev | 0.14 | 0.25 | 0.27 | 0.28 | 0.27 | 0.6% |

TABLE 4B
Film1 Ambient Aseptic Processing L Value

| Sample | | | | |
|---|---|---|---|---|
| Number | Baseline | 2 Month | 4 Month | Reduction |
| 1 | 51.08 | 51.07 | 51.10 | 0.0% |
| 2 | 51.24 | 51.35 | 51.05 | −0.4% |
| 3 | 51.03 | 51.46 | 51.41 | 0.7% |
| 4 | 51.21 | 51.31 | 51.05 | −0.3% |
| 5 | 51.04 | 51.29 | 51.13 | 0.2% |
| 6 | 50.97 | 51.35 | 51.15 | 0.4% |
| 7 | 51.22 | 51.18 | 50.86 | −0.7% |
| 8 | 50.79 | 51.34 | 50.81 | 0.0% |
| 9 | 51.04 | 51.24 | 51.09 | 0.1% |
| Avg | 51.07 | 51.29 | 51.07 | 0.0% |
| StdDev | 0.14 | 0.11 | 0.17 | 0.4% |

TABLE 4C
Film1 Accelerated Hot Fill Processing L Value

| Sample | | 1 | 2 | 3 | 4 | |
|---|---|---|---|---|---|---|
| Number | Baseline | Month | Month | Month | Month | Reduction |
| 1 | 51.78 | 51.55 | 50.31 | 49.57 | 48.24 | −6.8% |
| 2 | 51.86 | 51.54 | 50.34 | 49.43 | 48.35 | −6.8% |
| 3 | 52.03 | 51.52 | 50.55 | 49.35 | 48.87 | −6.1% |
| 4 | 51.72 | 52.04 | 50.53 | 49.58 | 47.76 | −7.7% |
| 5 | 51.79 | 52.05 | 50.74 | 49.47 | 47.84 | −7.6% |
| 6 | 51.95 | 51.97 | 50.54 | 49.69 | 47.83 | −7.9% |
| 7 | 51.79 | 52.01 | 50.90 | 49.44 | 47.32 | −8.6% |
| 8 | 52.04 | 51.97 | 51.15 | 49.69 | 47.16 | −9.4% |
| 9 | 51.86 | 51.99 | 50.91 | 49.21 | 47.19 | −9.0% |
| Avg | 51.87 | 51.85 | 50.66 | 49.49 | 47.84 | −7.8% |
| StdDev | 0.11 | 0.24 | 0.28 | 0.16 | 0.57 | 1.1% |

TABLE 4D
Film1 Ambient Hot Fill Processing L Value

| Sample | | | | |
|---|---|---|---|---|
| Number | Baseline | 2 Month | 4 Month | Reduction |
| 1 | 51.78 | 52.39 | 51.65 | −0.3% |
| 2 | 51.86 | 52.51 | 51.98 | 0.2% |
| 3 | 52.03 | 52.36 | 51.81 | −0.4% |
| 4 | 51.72 | 52.00 | 51.94 | 0.4% |
| 5 | 51.79 | 52.41 | 51.82 | 0.1% |
| 6 | 51.95 | 52.28 | 52.15 | 0.4% |
| 7 | 51.79 | 52.16 | 52.06 | 0.5% |
| 8 | 52.04 | 52.00 | 52.16 | 0.2% |
| 9 | 51.86 | 51.15 | 52.28 | 0.8% |
| Avg | 51.87 | 52.14 | 51.98 | 0.2% |
| StdDev | 0.11 | 0.41 | 0.20 | 0.4% |

A reduction in the L value, as shown in certain of the samples in Tables 4A, 4B, 4C and 4D, typically demonstrates a loss of color and perhaps a degradation of quality in the packaged item.

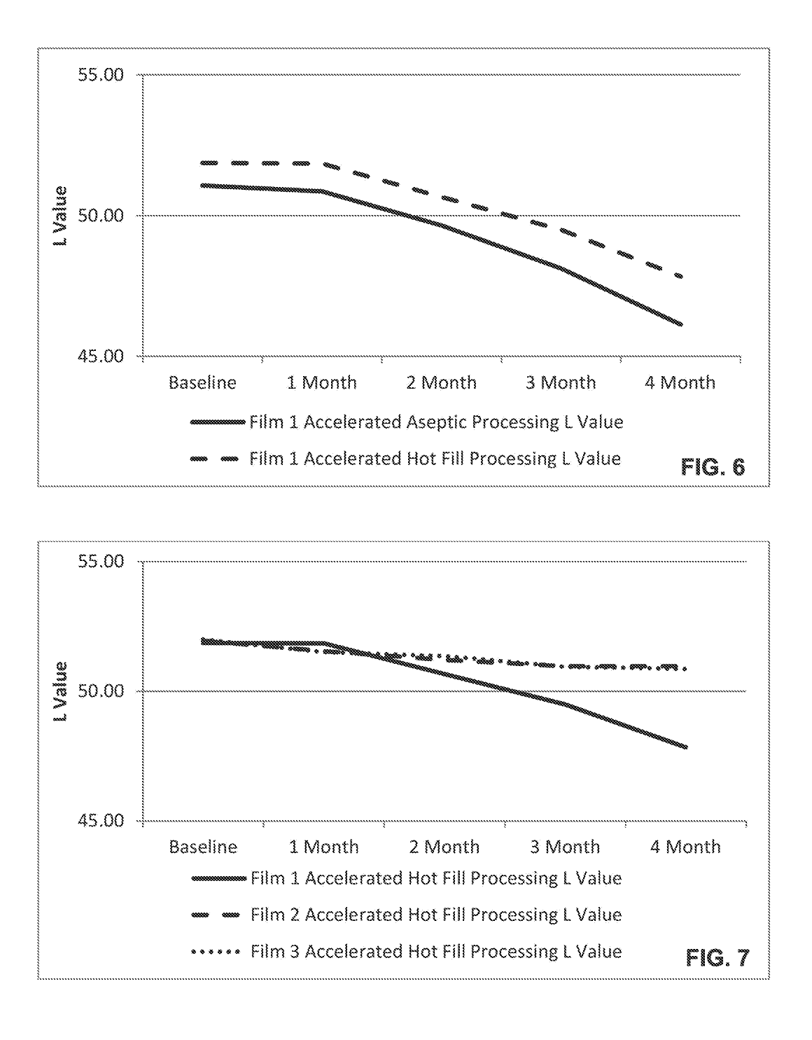

FIG. 6 provides a graphical representation of the change in L value for Film1 during accelerated test conditions for aseptic and hot fill processing.

### Example 2

Film2 and Film3 were subjected to accelerated hot fill processing testing. Accelerated process testing for Film1 was conducted at 37° C. The variation in L values for Film2 and Film3 from the baseline over the course of testing has been identified in Tables 5 and 6, respectively.

FIG. 7 provides a graphical representation of the change in L value for Film1 (see Example 1), Film2 and Film 3 during accelerated testing for hot fill processing. FIG. 7 illustrates that Film2 and Film3 performs better over time than Film1.

TABLE 5
Film2 Accelerated Hot Fill Processing L Value

| Sample | | 1 | 2 | 3 | 4 | |
|---|---|---|---|---|---|---|
| Number | Baseline | Month | Month | Month | Month | Reduction |
| 1 | 52.00 | 51.63 | 51.25 | 50.99 | 51.02 | −1.9% |
| 2 | 52.02 | 51.60 | 51.25 | 51.02 | 50.93 | −2.1% |
| 3 | 51.94 | 51.58 | 51.23 | 51.02 | 50.92 | −2.0% |
| 4 | 51.90 | 51.50 | 51.22 | 51.05 | 51.00 | −1.7% |
| 5 | 51.93 | 51.54 | 51.13 | 50.92 | 50.94 | −1.9% |
| 6 | 51.97 | 51.55 | 51.21 | 50.93 | 50.93 | −2.0% |
| 7 | 51.96 | 51.48 | 51.18 | 50.87 | 51.08 | −1.7% |
| 8 | 51.89 | 51.49 | 51.18 | 50.94 | 50.93 | −1.9% |
| Avg | 51.95 | 51.55 | 51.21 | 50.97 | 50.97 | −1.9% |
| StdDev | 0.05 | 0.05 | 0.04 | 0.06 | 0.06 | 0.1% |

TABLE 6
Film3 Accelerated Hot Fill Processing L Value

| Sample | | 1 | 2 | 3 | 4 | |
|---|---|---|---|---|---|---|
| Number | Baseline | Month | Month | Month | Month | Reduction |
| 1 | 51.96 | 51.47 | 51.40 | 51.03 | 50.90 | −2.0% |
| 2 | 51.97 | 51.48 | 51.36 | 50.98 | 50.89 | −2.1% |
| 3 | 51.93 | 51.46 | 51.35 | 50.92 | 50.91 | −2.0% |
| 4 | 51.98 | 51.55 | 51.39 | 50.99 | 50.96 | −2.0% |
| 5 | 51.95 | 51.58 | 51.30 | 50.94 | 50.82 | −2.2% |
| 6 | 52.46 | 51.49 | 51.33 | 50.94 | 50.74 | −3.3% |
| 7 | 51.90 | 51.53 | 51.36 | 50.88 | 50.79 | −2.1% |
| 8 | 51.81 | 51.53 | 51.37 | 50.92 | 50.88 | −1.8% |
| Avg | 52.00 | 51.51 | 51.36 | 50.95 | 50.86 | −2.2% |
| StdDev | 0.20 | 0.04 | 0.03 | 0.05 | 0.07 | 0.5% |

### Example 3

Due to its performance in the previous examples, Film1 was subjected to additional relatively testing involving a commercially available film type and film having layers similar to the layers of Film1. Film4 is a standard packaging film known in the art an example of which is generally described in Table 7. Suffice it to say these commercially available films do not include the layers of the invention such as those described in Tables 1A-1D.

TABLE 7
Example of Commercially Available Film

| | | Film4 |
|---|---|---|
| Layer | Component | Comp, wt % |
| 1 | LLDPE and Very Low Density Polyethylene | 67 |
| | (VLDPE) with Antiblock & Slip Additives (5 | |
| | wt %) and Fluoropolymer (1 wt %) | |
| | LDPE with Antiblock | 25 |
| | Additional Polymer Resin(s)/Additive(s) | 8 |
| 2 | LLDPE | 100 |
| 3 | Polyamide-6 | 100 |
| 4 | EVOH | 100 |
| 5 | Polyamide-6 | 100 |
| 6 | LLDPE | 100 |
| 7 | LLDPE and Very Low Density Polyethylene | 67 |
| | (VLDPE) with Antiblock & Slip Additives (5 | |
| | wt %) and Fluoropolymer (1 wt %) | |
| | LDPE with Antiblock | 25 |
| | Additional Polymer Resin(s)/Additive(s) | 8 |

Film5 identified in Table 8 is comparable to the films of the invention, but excludes many of the pigment based compound layers found in Film1. Film1 has been included to show the similarities and differences between the two films. One purpose of this additional testing between Film1 and Film5 is to show the impact that such inorganic compounds have on the ability of the films of the invention to improve shelf life of packaged high acid foods.

TABLE 8
Additional Multilayer Film Subject to Analysis Compared to Film1

| | | Film1 | | Film5 | |
|---|---|---|---|---|---|
| | | Table 1A | | Table 1E | |
| | | Thick | Comp | Thick | Comp |
| Layer | Component | mils | wt % | mils | wt % |
| 1 | LLDPE | 0.91 | 80.0 | 0.83 | 69.8 |
| | LDPE | | 0.0 | | 25.0 |
| | HDPE | | 6.4 | | 0.0 |
| | Ethylene/Hexene Copolymer | | 1.4 | | 0.0 |
| | Ethylene/Octene Copolymer | | 3.6 | | 4.5 |
| | Antiblock and Slip Additive | | 1.6 | | 0.7 |
| | Titanium Dioxide | | 6.5 | | 0.0 |
| | Carbon Black | | 0.4 | | 0.0 |
| 2 | LLDPE | 0.27 | 10.0 | 0.83 | 64.5 |
| | Maleic Anhydride-modified LLDPE | | 80.0 | | 0.0 |
| | Ethylene/Octene Copolymer | | 0.0 | | 35.5 |
| | Titanium Dioxide | | 10.0 | | 0.0 |
| 3 | Polyamide-6 | 0.27 | 100.0 | 0.18 | 0.0 |
| | Maleic Anhydride-modified LLDPE | | 0.0 | | 100.0 |
| 4 | Polyamide-6 | 0.32 | 0.0 | 0.15 | 100.0 |
| | Hydrolyzed Ethylene/Vinyl Acetate | | 50.0 | | 0.0 |
| | (EVA) Copolymer | | | | |
| | Hydrolyzed EVA with O₂ Scavenger | | 50.0 | | 0.0 |
| 5 | Polyamide-6 | 0.27 | 100.0 | 0.20 | 100.0 |
| 6 | LLDPE | 0.38 | 6.0 | 0.15 | 0.0 |
| | Maleic Anhydride-modified LLDPE | | 88.0 | | 0.0 |
| | Polyamide-6 | | 0.0 | | 100.0 |
| | Titanium Dioxide | | 6.0 | | 0.0 |
| 7 | LLDPE | 0.27 | 27.1 | 0.18 | 0.0 |
| | Maleic Anhydride-modified LLDPE | | 0.0 | | 100.0 |
| | HDPE | | 3.2 | | 0.0 |
| | Ethylene/Hexene Copolymer | | 1.4 | | 0.0 |
| | Ethylene/Norbornene Copolymer | | 60.0 | | 0.0 |
| | Antiblock and Slip Additive | | 0.8 | | 0.0 |
| | Titanium Dioxide | | 7.5 | | 0.0 |
| 8 | LLDPE | 0.02 | 0.0 | 0.83 | 64.5 |
| | Ethylene/Octene Copolymer | | 0.0 | | 35.5 |
| | Adhesive | | 100.0 | | 0.0 |
| 9 | PET-Silicon Oxide Coated | 0.48 | 100.0 | 0.01 | 0.0 |
| | Adhesive | | 0.0 | | 100.0 |
| 10 | Polyester-Aluminum Oxide Coated | 0.02 | 0.0 | 0.48 | 100.0 |
| | Adhesive | | 100.0 | | 0.0 |
| 11 | Commercially Available Film | 1.77 | 100.0 | 0.01 | 0.0 |
| | Adhesive | | 0.0 | | 100.0 |
| 12 | LLDPE | | | 0.83 | 69.8 |
| | LDPE | | | | 25.0 |
| | Ethylene/Octene Copolymer | | | | 4.5 |
| | Antiblock and Slip Additive | | | | 0.7 |
| 13 | LLDPE | | | 0.83 | 64.5 |
| | Ethylene/Octene Copolymer | | | | 35.5 |
| 14 | Maleic Anhydride-Modified LLDPE | | | 0.18 | 100.0 |
| 15 | Polyamide-6 | | | 0.15 | 100.0 |
| 16 | Polyamide-6 | | | 0.20 | 100.0 |
| 17 | Polyamide-6 | | | 0.15 | 100.0 |
| 18 | Maleic Anhydride-Modified LLDPE | | | 0.18 | 100.0 |
| 19 | LLDPE | | | 0.83 | 64.5 |
| | Ethylene/Octene Copolymer | | | | 35.5 |

As shown in Table 8, the core layer of Film5 is coated with a polyester-aluminum oxide inorganic barrier layer (layer 10) and is surrounded by identical film layer structures whereby such surrounding layers are substantially free of any pigment fillers. In contrast, the core layer of Film1 is coated with a PET-silicon oxide inorganic barrier layer (layer 9) and utilizes a commercial film structure on one side of the core layer substantially free of any pigment fillers while certain layers on the opposite of the core layer includes pigment fillers (TiO₂ and carbon black in layer 1 and TiO₂ in layers 2, 6 and 7). It is also noted that layer 4 of Film1 includes a hydrolyzed EVA with an oxygen scavenger, while Film5 has no such layer. The commercially available film, Film4, used in these tests had no core layer having an inorganic barrier layer, no other layers having pigment fillers, or any layers having an oxygen scavenger.

Accelerated storage conditions were conducted at 45° C. and 75% relative humidity, while ambient storage was over a temperature range of 20° C. to 25° C. Each of the samples were aseptically packaged in the corresponding film type and filled to a target weight of 3 kg (6.6 lbs). Three sample pouches were taken each month and agitated and emptied for color measurement. A triplicate sample was measured for color tristimulus values using a Hunter ColorFlex EZ with the color coordinates for these three samples being averaged.

Packages were filled under both aseptic processing (AP) conditions, as described herein, and heat pasteurization (HP) conditions. Heat pasteurization involved processing the mango puree at an internal temperature at 185° C. for five minutes prior to packaging, while aseptic processing did not involve such pasteurization. Heat pasteurization conditions are also known as hot fill processing as provided herein.

TABLE 9
Accelerated Aseptic Fill Processing CIE
L-a-b Values for Packaged Mango Puree

| | Average CIE L* | | | Average CIE a* | | | Average CIE b* | | |
|---|---|---|---|---|---|---|---|---|---|
| Month | Film4 | Film5 | Film1 | Film4 | Film5 | Film1 | Film4 | Film5 | Film1 |
| 0 | 50.82 | 50.66 | 51.07 | 15.06 | 15.01 | 15.20 | 60.23 | 59.93 | 60.67 |
| 1 | 48.24 | 50.10 | 50.86 | 15.52 | 16.12 | 16.41 | 57.57 | 59.29 | 61.39 |
| 2 | 43.28 | 48.23 | 49.65 | 14.19 | 15.93 | 16.41 | 50.73 | 58.54 | 60.69 |
| 3 | 38.79 | 47.52 | 48.12 | 13.05 | 15.96 | 16.32 | 43.86 | 57.73 | 58.80 |
| 4 | 36.85 | 44.99 | 46.13 | 13.14 | 15.82 | 16.42 | 42.20 | 54.53 | 56.50 |
| 5 | | 43.33 | 44.32 | | 15.58 | 16.28 | | 52.11 | 54.01 |
| 6 | | 42.20 | 43.64 | | 15.66 | 16.68 | | 50.67 | 53.23 |
| 7 | | 40.77 | 41.97 | | 15.46 | 16.70 | | 48.84 | 51.17 |
| 8 | | 39.44 | 40.24 | | 15.31 | 16.25 | | 47.44 | 48.49 |

Table 9 shows the CIE L-a-b values over the course of nine months for mango puree packaged under ambient temperature processing conditions in the three films—Film4, Film5 and Film1—under accelerated storage conditions.

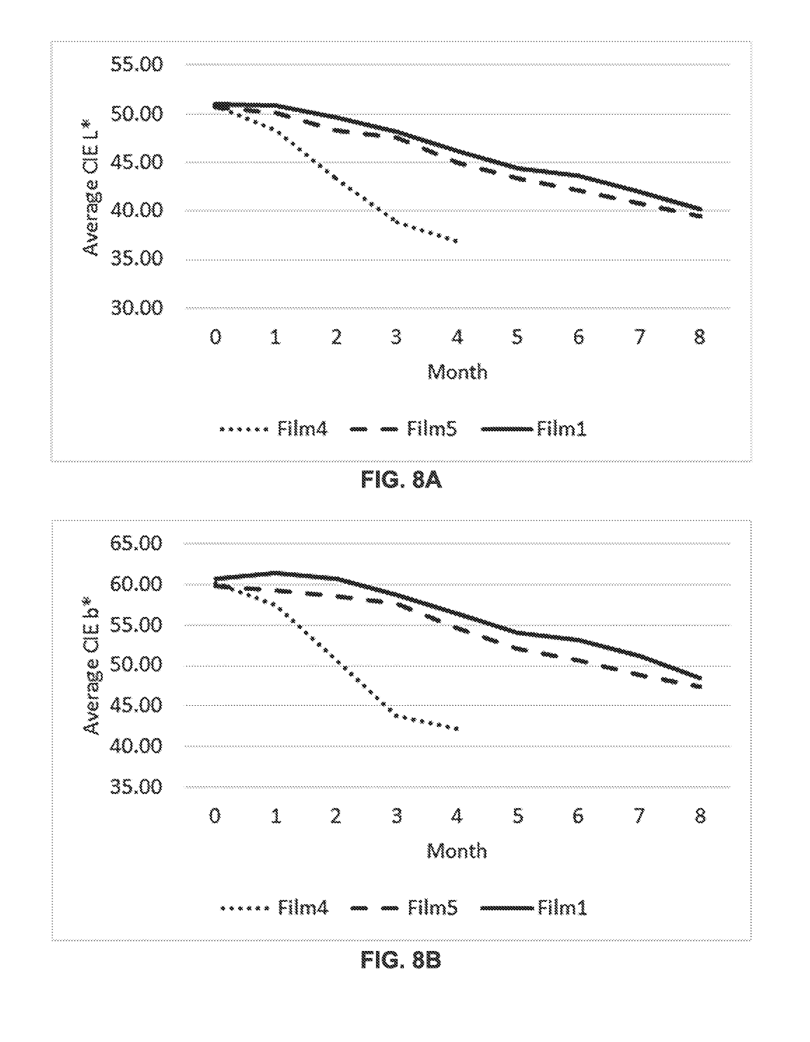

FIG. 8A provides a graphical representation of the change in the CIE L* value for Film4, Film5 and Film1 during accelerated test conditions for aseptic fill processing. FIG. 8B provides a graphical representation of the change in the CIE b* value for Film4, Film5 and Film1 during accelerated test conditions for aseptic fill processing.

Table 10 shows the percentage change in color space values of CIE L*, CIE a*, and CIE b* for the data reported in Table 9.

TABLE 10
Accelerated Aseptic Fill Processing % Change
in CIE L-a-b Values for Packaged Mango Puree

| | Change in Average CIE L* | | | Change in Average CIE a* | | | Change in Average CIE b* | | |
|---|---|---|---|---|---|---|---|---|---|
| Month | Film4 | Film5 | Film1 | Film4 | Film5 | Film1 | Film4 | Film5 | Film1 |
| 1 | −5.1% | −1.1% | −0.4% | 3.1% | 7.4% | 8.0% | −4.4% | −1.1% | 1.2% |
| 2 | −14.8% | −4.8% | −2.8% | −5.8% | 6.1% | 8.0% | −15.8% | −2.3% | 0.0% |
| 3 | −23.7% | −6.2% | −5.8% | −13.3% | 6.3% | 7.4% | −27.2% | −3.7% | −3.1% |
| 4 | −27.5% | −11.2% | −9.7% | −12.7% | 5.4% | 8.0% | −29.9% | −9.0% | −6.9% |
| 5 | | −14.5% | −13.2% | | 3.8% | 7.1% | | −13.0% | −11.0% |
| 6 | | −16.7% | −14.5% | | 4.3% | 9.7% | | −15.5% | −12.3% |
| 7 | | −19.5% | −17.8% | | 3.0% | 9.9% | | −18.5% | −15.7% |
| 8 | | −22.1% | −21.2% | | 2.0% | 6.9% | | −20.8% | −20.1% |

TABLE 11
Accelerated Hot Fill Processing CIE
L-a-b Values for Packaged Mango Puree

| | Average CIE L* | | | Average CIE a* | | | Average CIE b* | | |
|---|---|---|---|---|---|---|---|---|---|
| Month | Film4 | Film5 | Film1 | Film4 | Film5 | Film1 | Film4 | Film5 | Film1 |
| 0 | 50.98 | 52.21 | 51.87 | 15.14 | 15.93 | 15.84 | 60.34 | 62.38 | 61.91 |
| 1 | 45.08 | 51.54 | 51.85 | 14.42 | 16.35 | 16.50 | 52.52 | 62.17 | 62.84 |
| 2 | 45.34 | 49.91 | 50.66 | 14.89 | 16.20 | 16.48 | 53.96 | 60.85 | 61.95 |
| 3 | 38.39 | 48.49 | 49.49 | 12.77 | 16.28 | 16.43 | 43.79 | 59.24 | 60.62 |
| 4 | 35.47 | 45.83 | 47.84 | 12.60 | 16.16 | 16.41 | 39.43 | 55.98 | 58.58 |
| 5 | | 43.92 | 46.35 | | 16.01 | 16.81 | | 53.24 | 56.74 |
| 6 | | 42.78 | 45.57 | | 16.08 | 16.78 | | 51.93 | 55.14 |
| 7 | | 40.86 | 43.43 | | 15.88 | 16.61 | | 48.28 | 53.03 |
| 8 | | 38.09 | 42.11 | | 15.50 | 16.39 | | 46.16 | 51.59 |

Table 11 shows the CIE L-a-b values over the course of nine months for mango puree subjected to heat pasteurization conditions prior to being packaged in the three films—Film4, Film5 and Film1—under accelerated storage conditions.

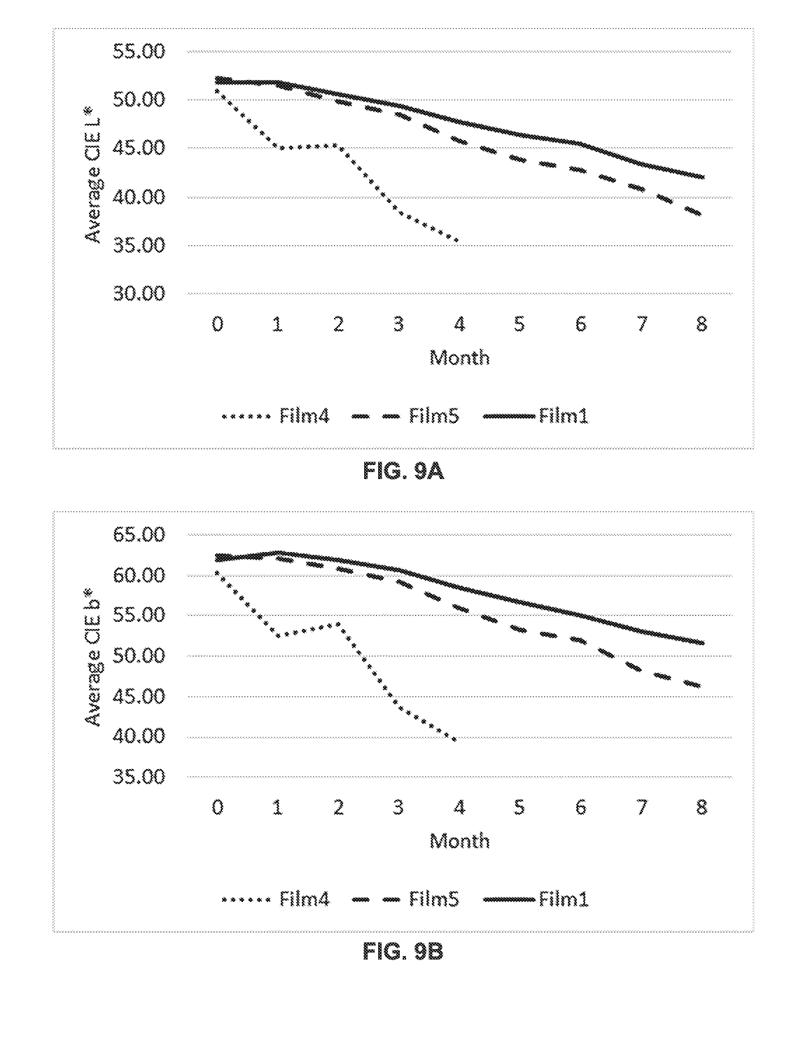

FIG. 9A provides a graphical representation of the change in the CIE L* value for Film4, Film5 and Film1 during accelerated test conditions for hot fill processing. FIG. 9B provides a graphical representation of the change in the CIE b* value for Film4, Film5 and Film1 during accelerated test conditions for aseptic hot processing.

Table 12 shows the percentage change in color space values of CIE L*, CIE a*, and CIE b* for the data reported in Table 10.

TABLE 12
Accelerated Hot Fill Processing % Change in
CIE L-a-b Values for Packaged Mango Puree

| | Change in Average CIE L* | | | Change in Average CIE a* | | | Change in Average CIE b* | | |
|---|---|---|---|---|---|---|---|---|---|
| Month | Film4 | Film5 | Film1 | Film4 | Film5 | Film1 | Film4 | Film5 | Film1 |
| 1 | −11.6% | −1.3% | 0.0% | −4.8% | 2.6% | 4.2% | −13.0% | −0.3% | 1.5% |
| 2 | −11.1% | −4.4% | −2.3% | −1.7% | 1.7% | 4.0% | −10.6% | −2.5% | 0.1% |
| 3 | −24.7% | −7.1% | −4.6% | −15.7% | 2.2% | 3.7% | −27.4% | −5.0% | −2.1% |
| 4 | −30.4% | −12.2% | −7.8% | −16.8% | 1.4% | 3.6% | −34.7% | −10.3% | −5.4% |
| 5 | | −15.9% | −10.6% | | 0.5% | 6.1% | | −14.7% | −8.4% |
| 6 | | −18.1% | −12.1% | | 0.9% | 5.9% | | −16.8% | −10.9% |
| 7 | | −21.7% | −16.3% | | −0.3% | 4.9% | | −22.6% | −14.3% |
| 8 | | −27.0% | −18.8% | | −2.7% | 3.5% | | −26.0% | −16.7% |

After two months of accelerated processing, the commercial film, Film4, showed significant browning, while Film1 and Film5 did not show any significant color change for both the aseptic process and heat pasteurization process packaged mango puree. The color measurement for mango puree packaged in Film4 was discontinued after four months due to extensive browning and an undesirable color perception.

The CIE L* value or the lightness value shows that Film1 and Film5 demonstrate a greater than two times the shelf life of Film1 under the accelerated test conditions. Indeed, under the accelerated testing, the mango puree of Film1 and Film5 maintained a bright or light yellow color for five to six months, while the mango puree of Film4 turned a dark brown within about 3 months. This is further confirmed by the rapid deterioration in CIE b*, the yellow color coordinate, for Film4, while Film1 showed the best overall response in CIE b* over the course of testing under accelerated testing followed by Film5. While Film1 showed a perceived dark yellow, the packaged mango puree still maintained an acceptable color even after being stored for eight months under higher temperature and high humidity accelerated test conditions.

Table 13 shows the CIE L-a-b values over the course of fourteen months for mango puree packaged under ambient temperature processing conditions in the three films—Film4, Film5 and Film1—under ambient storage conditions.

TABLE 13
Ambient Aseptic Fill Processing CIE
L-a-b Values for Packaged Mango Puree

| | Average CIE L* | | | Average CIE a* | | | Average CIE b* | | |
|---|---|---|---|---|---|---|---|---|---|
| Month | Film4 | Film5 | Film1 | Film4 | Film5 | Film1 | Film4 | Film5 | Film1 |
| 0 | 50.82 | 50.66 | 51.07 | 15.06 | 15.01 | 15.20 | 60.23 | 59.93 | 60.67 |
| 2 | 50.45 | 50.93 | 51.29 | 15.64 | 15.80 | 15.95 | 60.09 | 60.97 | 61.42 |
| 4 | 49.84 | 50.53 | 51.07 | 15.47 | 15.71 | 15.98 | 59.47 | 60.40 | 61.25 |
| 6 | 48.09 | 50.12 | 51.08 | 14.88 | 16.09 | 16.08 | 56.90 | 60.31 | 61.33 |
| 8 | 47.84 | 49.09 | 50.89 | 15.44 | 15.74 | 16.18 | 56.82 | 58.62 | 61.08 |
| 10 | 45.81 | 48.75 | 50.84 | 14.70 | 15.68 | 16.13 | 54.26 | 57.89 | 61.26 |
| 12 | 43.02 | 48.19 | 50.84 | 14.09 | 15.46 | 16.34 | 49.50 | 57.12 | 61.17 |
| 14 | 42.63 | 47.53 | 50.40 | 14.13 | 15.37 | 16.16 | 48.53 | 56.28 | 60.68 |

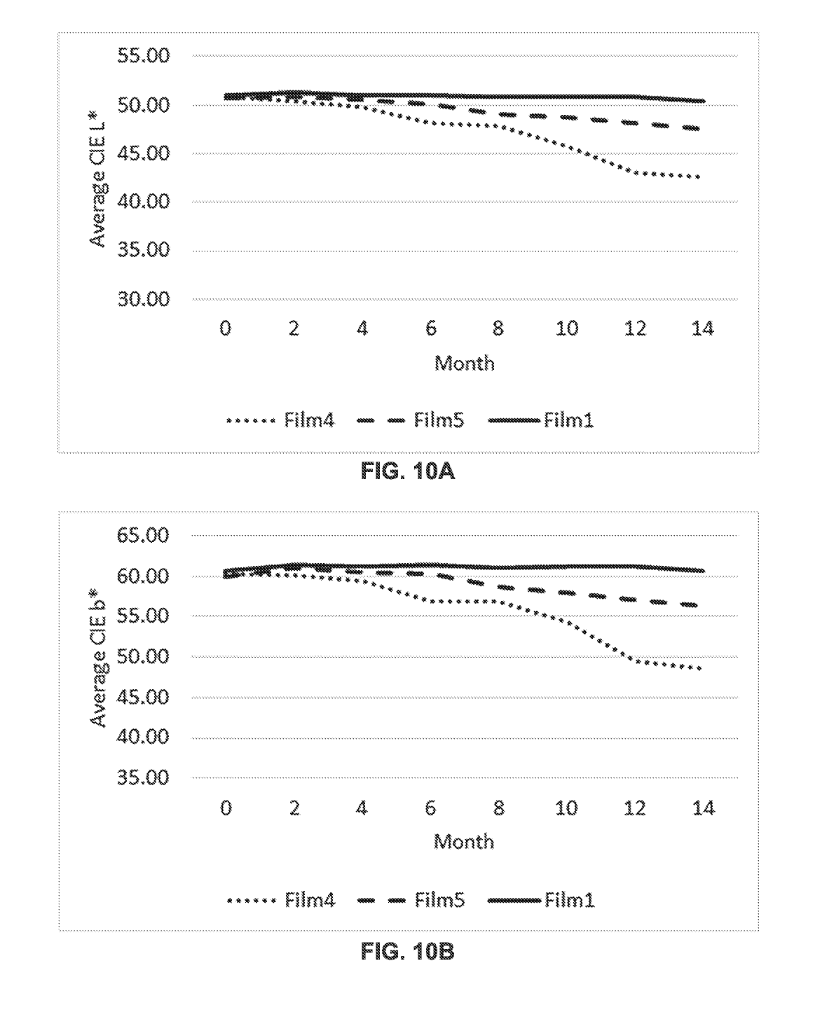

FIG. 10A provides a graphical representation of the change in the CIE L* value for Film4, Film5 and Film1 during ambient test conditions for aseptic fill processing. FIG. 10B provides a graphical representation of the change in the CIE b* value for Film4, Film5 and Film1 during ambient test conditions for aseptic fill processing.

Table 14 shows the percentage change in color space values of CIE L*, CIE a*, and CIE b* for the data reported in Table 13.

TABLE 14
Ambient Aseptic Fill Processing % Change CIE L-a-b Values for Packaged Mango Puree

| | Change in Average CIE L* | | | Change in Average CIE a* | | | Change in Average CIE b* | | |
|---|---|---|---|---|---|---|---|---|---|
| Month | Film4 | Film5 | Film1 | Film4 | Film5 | Film1 | Film4 | Film5 | Film1 |
| 2 | −0.7% | 0.5% | 0.4% | 3.9% | 5.3% | 4.9% | −0.2% | 1.7% | 1.2% |
| 4 | −1.9% | −0.3% | 0.0% | 2.7% | 4.7% | 5.1% | −1.3% | 0.8% | 1.0% |
| 6 | −5.4% | −1.1% | 0.0% | −1.2% | 7.2% | 5.8% | −5.5% | 0.6% | 1.1% |
| 8 | −5.9% | −3.1% | −0.4% | 2.5% | 4.9% | 6.4% | −5.7% | −2.2% | 0.7% |
| 10 | −9.9% | −3.8% | −0.5% | −2.4% | 4.5% | 6.1% | −9.9% | −3.4% | 1.0% |
| 12 | −15.3% | −4.9% | −0.5% | −6.4% | 3.0% | 7.5% | −17.8% | −4.7% | 0.8% |
| 14 | −16.1% | −6.2% | −1.3% | −6.2% | 2.4% | 6.3% | −19.4% | −6.1% | 0.0% |

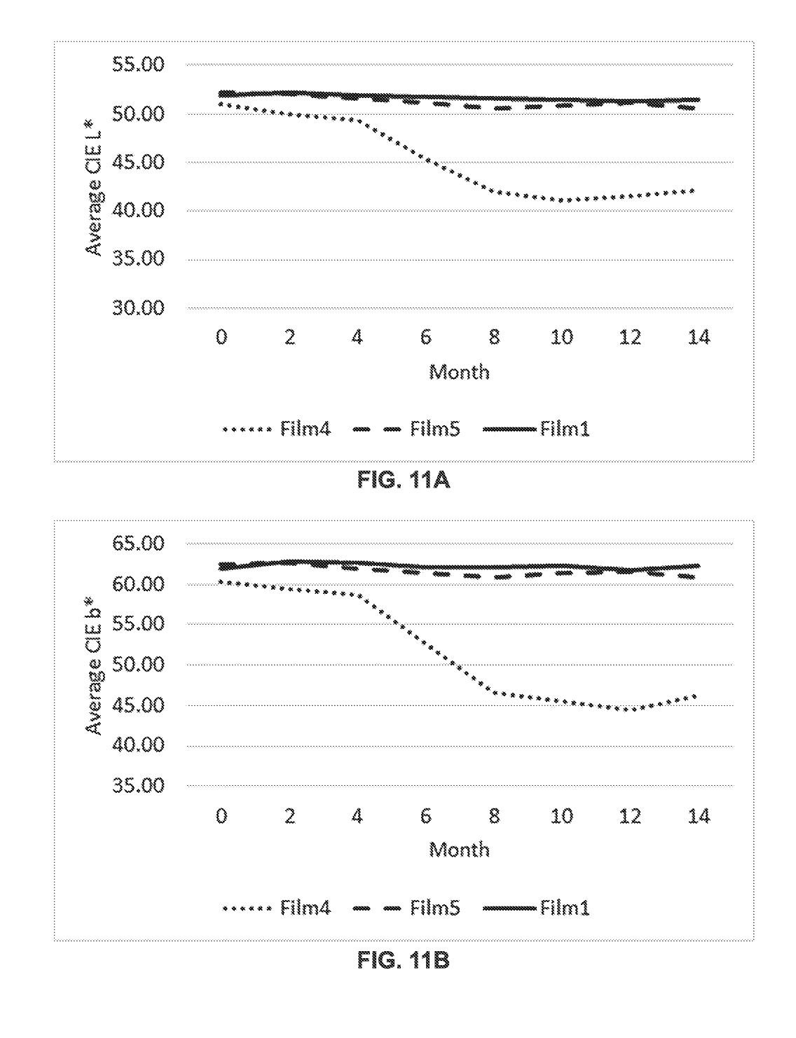

FIG. 11A provides a graphical representation of the change in the CIE L* value for Film4, Film5 and Film1 during ambient test conditions for hot fill processing. FIG. 11B provides a graphical representation of the change in the CIE b* value for Film4, Film5 and Film1 during ambient test conditions for aseptic hot processing.

Table 15 shows the CIE L-a-b values over the course fourteen months for mango puree subjected to heat pasteurization (HP) conditions prior to being packaged in the three films—Film4, Film5 and Film1—under ambient storage conditions.

TABLE 15
Ambient Hot Fill Processing CIE L-
a-b Values for Packaged Mango Puree

| | Average CIE L* | | | Average CIE a* | | | Average CIE b* | | |
|---|---|---|---|---|---|---|---|---|---|
| Month | Film4 | Film5 | Film1 | Film4 | Film5 | Film1 | Film4 | Film5 | Film1 |
| 0 | 50.98 | 52.21 | 51.87 | 15.14 | 15.93 | 15.84 | 60.34 | 62.38 | 61.91 |
| 2 | 49.88 | 52.02 | 52.14 | 15.56 | 16.41 | 16.34 | 59.43 | 62.62 | 62.87 |
| 4 | 49.29 | 51.54 | 51.98 | 15.41 | 16.10 | 16.26 | 58.64 | 61.90 | 62.68 |
| 6 | 45.32 | 51.14 | 51.73 | 14.36 | 15.98 | 16.14 | 52.49 | 61.44 | 62.16 |
| 8 | 41.93 | 50.62 | 51.56 | 13.47 | 15.92 | 16.34 | 46.56 | 60.92 | 62.11 |
| 10 | 41.12 | 50.85 | 51.53 | 13.72 | 16.22 | 16.42 | 45.53 | 61.32 | 62.26 |
| 12 | 41.59 | 51.19 | 51.35 | 13.23 | 16.11 | 16.49 | 44.36 | 61.53 | 61.83 |
| 14 | 42.13 | 50.60 | 51.52 | 13.96 | 16.10 | 16.48 | 46.31 | 60.77 | 62.28 |

Table 16 shows the percentage change in color space values of CIE L*, CIE a*, and CIE b* for the data reported in Table 14.

TABLE 16
Ambient Hot Fill Processing % Change CIE L-a-b Values for Packaged Mango Puree

| | Change in Average CIE L* | | | Change in Average CIE a* | | | Change in Average CIE b* | | |
|---|---|---|---|---|---|---|---|---|---|
| Month | Film4 | Film5 | Film1 | Film4 | Film5 | Film1 | Film4 | Film5 | Film1 |
| 2 | −2.2% | −0.4% | 0.5% | 2.8% | 3.0% | 3.2% | −1.5% | 0.4% | 1.6% |
| 4 | −3.3% | −1.3% | 0.2% | 1.8% | 1.1% | 2.7% | −2.8% | −0.8% | 1.2% |
| 6 | −11.1% | −2.0% | −0.3% | −5.2% | 0.3% | 1.9% | −13.0% | −1.5% | 0.4% |
| 8 | −17.8% | −3.0% | −0.6% | −11.0% | −0.1% | 3.2% | −22.8% | −2.3% | 0.3% |
| 10 | −19.3% | −2.6% | −0.7% | −9.4% | 1.8% | 3.7% | −24.5% | −1.7% | 0.6% |
| 12 | −18.4% | −2.0% | −1.0% | −12.6% | 1.1% | 4.1% | −26.5% | −1.4% | −0.1% |
| 14 | −17.4% | −3.1% | −0.7% | −7.8% | 1.1% | 4.0% | −23.3% | −2.6% | 0.6% |

After six months of testing under ambient conditions, Film4 show slight darkening relative to Film1 and Film5 for both aseptic processing and heat pasteurization processing. Film4, with a decrease in the CIE L* lightness coordinate, demonstrated a significant darkening within about six months under ambient test conditions, while it demonstrated a similar darkening response within two months under accelerated test conditions. Film1 showed no significant change in lightness (CIE L*) or yellowness (CIE b*) after fourteen months of ambient tests conditions for both aseptic process and hot pasteurization process mango puree.

In summary, Film1 showed the best color retention in lightness (CIE L*) and yellowness (CIE b*) in comparison to Film4 and Film5 for both storage at 45° C. and 75% relative humidity accelerated test conditions and under 20° C. to 25° C. ambient test conditions. While Film5 performed significantly better than Film4, Film1 still had the best overall results.

Many modifications and other embodiments of the invention set forth herein will come to mind to one skilled in the art to which this invention pertains having the benefit of the teachings presented in the descriptions herein and the associated drawings. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

That which is claimed:

1. A multilayer film comprising:
an inorganic core layer having
a support layer and
an inorganic barrier layer; and
an outer barrier sealant layer upon which the inorganic core layer is disposed.

2. The multilayer film of claim 1, wherein the inorganic barrier layer comprises any one of a silicon oxide (SiOₓ) and an aluminum oxide (AlOₓ).

3. The multilayer film of claim 1, wherein the outer barrier sealant layer comprises a central core layer.

4. The multilayer film of claim 3, wherein the central core layer comprises:
a barrier layer having a resin providing barrier properties;
a first outer barrier layer upon which the barrier layer is disposed; and
a second outer barrier layer on a side opposite the barrier layer where the first outer barrier layer is disposed.

5. The multilayer film of claim 4, wherein the resin comprises an ethylene vinyl alcohol copolymer (EVOH).

6. The multilayer film of claim 5, wherein the resin additionally comprises an oxygen absorber.

7. The multilayer film of claim 5, wherein at least one of the first outer barrier layer and the second outer barrier layer comprises a nylon 6.

8. The multilayer film of claim 4, wherein the barrier layer comprises at least one nylon 6 layer.

9. The multilayer film of claim 8, wherein at least one of the first outer barrier layer and the second outer barrier layer comprises a maleic anhydride modified linear low density polyethylene (LLDPE).

10. The multilayer film of claim 3, additionally comprising an outer layer affixed to a side of the central core layer by a first tie layer.

11. The multilayer film of claim 10, additionally comprising a second tie layer disposed between another side of the central core layer and the inorganic core layer.

12. The multilayer film of claim 11, wherein the outer layer comprises a polyethylene resin that provides a good heat seal in a finished product comprising the multilayer film.

13. The multilayer film of claim 10, wherein the outer layer comprises a pigment.

14. The multilayer film of claim 13, wherein the pigment comprises at least one of a titanium dioxide (TiO₂) and a carbon black.

15. The multilayer film of claim 13, a concentration of the pigment is from about 6 wt % to about 10 wt % based upon an overall weight of the outer layer.

16. The multilayer film of claim 11, wherein at least one of the first tie layer and the second tie layer comprises a pigment.

17. The multilayer film of claim 1, additionally comprising another outer barrier sealant layer on a side of the inorganic core layer opposite to where the outer barrier sealant layer is disposed.

18. The multilayer film of claim 17, additionally comprising another inorganic core layer disposed between the inorganic core layer and the another outer barrier sealant layer.

19. The multilayer film of claim 11, wherein another second tie layer is disposed on a side opposite of the inorganic core layer in which the tie layer is disposed and another central core layer disposed between the another second tie layer and another first tie layer.

20. The multilayer film of claim 19, wherein at least one of the another first tie layer, the another central core layer, and the another second tie layer have the same properties as the first tie layer, the central core layer, and the second tie layer, respectively.
